(19) United States
(12) Patent Application Publication
(10) Pub. No.: US 2010/0000849 A1
(43) Pub. Date: Jan. 7, 2010

(54) Method Of Prevention Of Ethanol In Rectification Column Bottoms In An Ethanol Plant

(75) Inventors: D. Christopher Romer, Memphis, TN (US); Richard Hopkins, Marionville, MO (US)

Correspondence Address: AIR LIQUIDE;Intellectual Property, 2700 POST OAK BOULEVARD, SUITE 1800, HOUSTON, TX, 77056, US

(73) Assignee: Lurgi PSI, Inc., Memphis, TN (US)

(21) Appl. No.: 12/495,831

(22) Filed: Jul. 1, 2009

Related U.S. Application Data
(60) Provisional application No. 61/077,943, filed on Jul. 3, 2008.

(51) Int. Cl. B01D 3/42

(52) U.S. Cl. 203/2

(57) ABSTRACT

A method for preventing ethanol buildup in a column including providing a column with a bottom temperature and a next temperature above the bottom; providing a first advisory, wherein said first advisory comprises a temperature difference between said bottom temperature and said next temperature above the bottom that exceeds a first predetermined value, wherein a first action is taken should this first advisory occur; providing a second advisory, wherein said second advisory comprises a temperature depression of said bottom temperature of a second predetermined value, wherein a second action is taken should this second advisory occur, and providing a third advisory, wherein said third advisory comprises a temperature depression of said bottom temperature of a third predetermined value, wherein a third action is taken should this third advisory occur is provided.

This application claims the benefit of U.S. Provisional Application No. 61/077,943, filed Jul. 3, 2008, the entire contents of which are incorporated herein by reference.

### BACKGROUND

A variety of cereal grains and other plants are grown for use as food. Major cereal grains include corn, rice, wheat, barley, sorghum (milo), millets, oats, and rye. Other plants include potatoes, cassava, and artichokes. Corn is the most important cereal grain grown in the United States. A mature corn plant consists of a stalk with an ear of corn encased within a husk. The ear of corn consists of about 800 kernels on a cylindrical cob. The kernels are eaten whole and are also processed into a wide variety of food and industrial products. The other parts of the corn plant (i.e., the stalk, leaves, husk, and cob) are commonly used for animal feed, but are sometimes processed into a variety of food and industrial products.

In more detail, the corn kernel consist of three main parts: (1) the pericarp; (2) the endosperm; and (3) the germ. The pericarp (also known as the seed coat or bran) is the outer covering of the kernel. It consists primarily of relatively coarse fiber. The endosperm is the energy reserve for the plant. It consists primarily of starch, protein (also known as gluten), and small amounts of relatively fine fiber. The germ (also known as the embryo) consists primarily of oil and a miniature plant with a root-like portion and several embryonic leaves.

Starch is stored in a corn kernel in the form of discrete crystalline bodies known as granules. Starch is a member of the general class of carbohydrates known as polysaccharides. Polysaccharides contain multiple saccharide units (in contrast to disaccharides which contain two saccharide units and monosaccharides which contain a single saccharide unit). The length of a saccharide chain (the number of saccharide units in it) is sometimes described by stating its “degree of polymerization” (abbreviated to D.P.). Starch has a D.P. of 1000 or more. Glucose (also known as dextrose) is a monosaccharide (its D.P. is 1). Saccharides having a D.P. of about 5 or less are sometimes referred to as sugars.

As mentioned above, the pericarp and endosperm of the corn kernel contain fiber. The fiber comprises cellulose, hemicellulose, lignin, pectin, and relatively small amounts of other materials. Fiber is present in relatively small amounts in the corn kernel, but is present in much greater amounts in other corn components such as the cob, husk, leaves, and stalk. Fiber is also present in other plants. The combination of cellulose and lignin is sometimes known as lignocellulose and the combination of cellulose, lignin, and hemicellulose is sometimes known as lignocellulosic biomass. As used herein, the term “fiber” (and its alternative spelling “fibre”) refers to cellulose, hemicellulose, lignin, and pectin.

A wide variety of processes have been used to separate the various components of corn. These separation processes are commonly known as corn refining. One of the processes is known as the dry milling process. In this process, the corn kernels are first cleaned and then soaked in water to increase their moisture content. The softened corn kernels are then ground in coarse mills to break the kernel into three basic types of pieces—pericarp, germ, and endosperm. The pieces are then screened to separate the relatively small pericarp and germ from the relatively large endosperm. The pericarp and the germ are then separated from each other. The germs are then dried and the oil is removed. The remaining germ is typically used for animal feed. The endosperm (containing most of the starch and protein from the kernel) is further processed in various ways. As described below, one of the ways is to convert the starch to glucose and then ferment the glucose to ethanol.

Fermentation is a process by which microorganisms such as yeast digest sugars to produce ethanol and carbon dioxide. Yeast reproduce aerobically (oxygen is required) but can conduct fermentation anaerobically (without oxygen). The fermented mixture (commonly known as the beer mash) is then distilled to recover the ethanol. Distillation is a process in which a liquid mixture is heated to vaporize the components having the highest vapor pressures (lowest boiling points). The vapors are then condensed to produce a liquid that is enriched in the more volatile compounds.

With the ever-increasing depletion of economically recoverable petroleum reserves, the production of ethanol from vegetative sources as a partial or complete replacement for conventional fossil-based liquid fuels becomes more attractive. In some areas, the economic and technical feasibility of using a 90% unleaded gasoline-10% anhydrous ethanol blend (“gasohol”) has shown encouraging results. According to a recent study, gasohol powered automobiles have averaged a 5% reduction in fuel compared to unleaded gasoline powered vehicles and have emitted one-third less carbon monoxide than the latter. In addition to offering promise as a practical and efficient fuel, biomass-derived ethanol in large quantities and at a competitive price has the potential in some areas for replacing certain petroleum-based chemical feedstocks. Thus, for example, ethanol can be catalytically dehydrated to ethylene, one of the most important of all chemical raw materials both in terms of quantity and versatility.

### SUMMARY

The present invention is a method for preventing ethanol buildup in a column including providing a column with a bottom temperature and a next temperature above the bottom; providing a first advisory, wherein said first advisory comprises a temperature difference between said bottom temperature and said next temperature above the bottom that exceeds a first predetermined value, wherein a first action is taken should this first advisory occur; providing a second advisory, wherein said second advisory comprises a temperature depression of said bottom temperature of a second predetermined value, wherein a second action is taken should this second advisory occur, and providing a third advisory, wherein said third advisory comprises a temperature depression of said bottom temperature of a third predetermined value, wherein a third action is taken should this third advisory occur.

### DESCRIPTION OF PREFERRED EMBODIMENTS

Operation of the beer and rectification columns at the proper temperature and pressure is very important to ensure that the ethanol concentration is sufficiently low in the bottoms. The beer column bottoms should be less than about 300 ppm and the rectifier column bottoms should be less than about 300 ppm. The proper temperatures at set pressures must be established, and the proper actions to be taken if the temperatures are lower than the target must be defined. In one embodiment of the present invention, there are three advisory levels that may alert the operator to take corrective action. The first may be a differential temperature between the bottom temperature and the next temperature above the bottom. The second may be a low bottom temperature indicating ethanol in bottoms exceeding 300 ppm. The third may be a low low bottom temperature indicating ethanol in bottoms exceeding 10,000 ppm. The first two advisories may prompt the operator to correct the situation. The third advisory may prompt the operator to divert the column bottoms to the beer well.

Beer Column

The beer column is typically designed to run at about 10.2 psia at the top with a nominal 2 psi pressure drop, resulting in a bottom design temperature of about 203 deg. F. In actual service it is possible that the column pressures may vary, which would thereby change the bottom temperature. For this reason it is necessary to know the bottom pressure in order to predict the correct bottom temperature. Since the bottoms should contain very little ethanol, steam tables may be used to determine the correct bottom temperature based on the bottom pressure within acceptable accuracy.

Advisory Level 1

The normal differential temperature between the bottom temperature and the next temperature above the bottom should be 7.4 deg. F. at design conditions. A larger temperature difference indicates higher ethanol concentrations at the upper location and the potential for increased ethanol in the column bottoms if the situation is not rectified. Since ethanol is building up and moving down the column, the solution is to reverse the trend by either adding more heat to the column, or reducing the beer feed (which is the reflux). At this stage a small incremental adjustment and monitoring for the next few minutes is probably all that is required.

Advisory Level 2

Ethanol in the column bottoms will cause a low bottom temperature. Approximately 1000 ppm ethanol in the bottoms will lower the measured temperature by approximately 0.2 degrees. This quantity of ethanol will not cause a safety hazard in the process condensate or whole stillage tanks, but it will typically result in a yield loss and should be corrected without delay. Reducing the beer feed is the quickest way to solve the problem. The situation should be closely monitored until it is determined that the problem has been solved.

Advisory Level 3

Should the ethanol level in the bottoms reach 10,000 ppm (approx. 1%), immediate action may be required to prevent a hazardous situation from occurring. If the bottom temperature goes below normal by 2.3 degrees, the whole stillage flash valve should be closed, and the whole stillage flash flow should be switched from the whole stillage tank to the beer well.

Rectifier Column

The rectifier column is designed to run at about 61.7 psia at the top with a nominal 3 psi pressure drop, resulting in a bottom design temperature of about 297.6 deg. F. In actual service it is possible that the column pressures may vary which would consequently change the bottom temperature. For this reason it is necessary to know the bottom pressure in order to predict the correct bottom temperature. Since the bottoms should contain very little ethanol, steam tables can be used to determine the correct bottom temperature based on the bottom pressure, with sufficienty accuracy.

Advisory Level 1

The normal differential temperature between bottom temperature and the next temperature above bottom should be about 24.2 deg. F. at design conditions. A larger temperature difference indicates higher ethanol concentrations at the upper location and the potential for increased ethanol in the column bottoms if the situation is not rectified. Since ethanol is building up and moving down the column, the solution is to reverse the trend by either increasing steam to reboiler, or reducing the feed to the distillation system by reducing beer feed. At this stage a small incremental adjustment and monitoring for the next few minutes is probably all that is required.

Advisory Level 2

Ethanol in the column bottoms will cause a low bottom temperature. Approximately 1000 ppm ethanol in the bottoms will lower bottom temperature by approximately 0.3 degrees. This quantity of ethanol will not cause a safety hazard in the mix tanks, but it does represent a yield loss and should be corrected without delay. Increasing steam to the reboiler is the quickest way to solve the problem. The situation should be closely monitored until it is determined that the problem has been solved.

Advisory Level 3

Should the ethanol level in the bottoms reach 10,000 ppm (approx. 1%), immediate action is required to prevent a hazardous situation from occurring. If the bottom temperature goes below normal by 4.4 degrees, the RC bottoms tlash flow should be switched from cook water to the beer well.

### Possible Embodiments

In one embodiment, the DCS may be programmed with the proper pressure/temperature correlation for the beer column so the operator will know at all times if the column bottom temperature is correct. A correct temperature may be shown as normal and change color when a deviation of 0.2 degrees occurs.

In another embodiment, the DCS may be programmed with the proper pressure/temperature correlation for the rectifier column so the operator will know at all times if the column bottom temperature is correct. A correct temperature will show as normal and change color when a deviation of 0.2 degrees occurs.

In another embodiment, the DCS may be programmed with a pop-up screen to alert the operator if a differential temperature greater than a predetermined amount (for example 7.4 degrees) exists between the bottom temperature and the next temperature above bottom on the beer column. The Advisory may state something like: “Advisory—Low Temperature at (bottom temperature sensor)—Potential for Ethanol in Beer Bottoms—Please take corrective action!”

In another embodiment, the DCS may be programmed with a pop-up screen to alert the operator if the bottom temperature is 0.2 degrees below normal. The Advisory may state something like: “Warning—Low Temperature at (bottom temperature sensor)—Ethanol in Beer Bottoms—Immediate corrective action required!”

In another embodiment, the DCS may be programmed with a pop-up screen to alert the operator if the bottom temperature is 2.3 degrees below normal. The Advisory may state something like: “Alarm—Low Low Temperature at (bottom temperature sensor)—Ethanol concentration˜1% in Beer Bottoms—Divert to Beer Well!”

In another embodiment, the DCS may be programmed with a pop-up screen to alert the operator if a differential temperature greater than 24.2 degrees exists between the bottom temperature and the next temperature above the bottom on the rectifier column. The Advisory may state something like: “Advisory—Low Temperature at (bottom temperature sensor)—Potential for Ethanol in Rectifier Bottoms—Please take corrective action!”

In another embodiment, the DCS may be programmed with a pop-up screen to alert the operator if the bottom temperature is 0.3 degrees below normal. The Advisory may state something like: “Warning—Low Temperature at (bottom temperature sensor)—Ethanol in Rectifier Bottoms—Immediate corrective action required!”

In another embodiment, the DCS may be programmed with a pop-up screen to alert the operator if the bottom temperature is 4.4 degrees below normal. The Advisory may state something like: “Alarm—Low Low Temperature at (bottom temperature sensor)—Ethanol concentration˜1% in Rectifier Bottoms—Divert to Beer Well!”

What is claimed is:

1. A method for preventing ethanol buildup in a column comprising:
providing a column with a bottom temperature and a next temperature above the bottom,
providing a first advisory, wherein said first advisory comprises a temperature difference between said bottom temperature and said next temperature above the bottom that exceeds a first predetermined value, wherein a first action is taken should this first advisory occur,
providing a second advisory, wherein said second advisory comprises a temperature depression of said bottom temperature of a second predetermined value, wherein a second action is taken should this second advisory occur, and
providing a third advisory, wherein said third advisory comprises a temperature depression of said bottom temperature of a third predetermined value, wherein a third action is taken should this third advisory occur.

2. The method for preventing ethanol buildup in a column of claim 1, wherein said column is of the type selected from the group consisting of beer column and rectifier column.

3. The method for preventing ethanol buildup in a column of claim 1, wherein said column is a beer column, and said bottom temperature is about 203 F.

4. The method for preventing ethanol buildup in a column of claim 1, wherein said column is a beer column, said first predetermined value is about 7.4 F, said second predetermined value is about 0.2 F, and said third predetermined value is about 2.3 F.

5. The method for preventing ethanol buildup in a column of claim 4, wherein said first action comprises a small predetermined incremental adjustment and monitoring for a predetermined short duration.

6. The method for preventing ethanol buildup in a column of claim 4, further comprising a DCS and an operator, wherein said first action comprises programming the DCS with a pop-up screen to alert the operator if a differential temperature greater than a first predetermined amount exists between the bottom temperature and the next temperature above bottom on the beer column.

7. The method for preventing ethanol buildup in a column of claim 6, wherein said Advisory may states: “Advisory—Low Temperature at bottom temperature sensor—Potential for Ethanol in Beer Bottoms—Please take corrective action!”.

8. The method for preventing ethanol buildup in a column of claim 4, further comprising a DCS and an operator, wherein said second action comprises programming the DCS with a pop-up screen to alert the operator if a differential temperature greater than a second predetermined amount exists between the bottom temperature and the next temperature above bottom on the beer column.

9. The method for preventing ethanol buildup in a column of claim 8, wherein said Advisory may states: “Warning—Low Temperature at bottom temperature sensor—Ethanol in Beer Bottoms—Immediate corrective action required!”.

10. The method for preventing ethanol buildup in a column of claim 4, further comprising a DCS and an operator, wherein said first action comprises programming the DCS with the proper pressure/temperature correlation for the beer column so the operator will know at all times if the column bottom temperature is correct.

11. The method for preventing ethanol buildup in a column of claim 10, further comprising indicating correct temperature as normal and indicating a change color when a deviation of 0.2 degrees occurs.

12. The method for preventing ethanol buildup in a column of claim 4, further comprising a DCS and an operator, wherein said third action comprises programming the DCS with a pop-up screen to alert the operator if the bottom temperature is 2.3 degrees below normal.

13. The method for preventing ethanol buildup in a column of claim 12, wherein said Advisory may states: “Alarm—Low Low Temperature at bottom temperature sensor—Ethanol concentration˜1% in Beer Bottoms—Divert to Beer Well!”

14. The method for preventing ethanol buildup in a column of claim 1, wherein said column is a rectifier column, and said bottom temperature is about 297.6 F.

15. The method for preventing ethanol buildup in a column of claim 1, wherein said column is a rectifier column, said first predetermined value is about 24.2 F, said second predetermined value is about 0.3 F, and said third predetermined value is about 4.4 F.

16. The method for preventing ethanol buildup in a column of claim 15, wherein said first action comprises a small predetermined incremental adjustment and monitoring for a predetermined short duration.

17. The method for preventing ethanol buildup in a column of claim 15, further comprising a DCS and an operator, wherein said first action comprises programming the DCS with a pop-up screen to alert the operator if a differential temperature greater than a first predetermined amount exists between the bottom temperature and the next temperature above bottom on the rectifier column.

18. The method for preventing ethanol buildup in a column of claim 17, wherein said Advisory may states: “Advisory—Low Temperature at bottom temperature sensor—Potential for Ethanol in Rectifier Bottoms—Please take corrective action!”.

19. The method for preventing ethanol buildup in a column of claim 15, further comprising a DCS and an operator, wherein said second action comprises programming the DCS with a pop-up screen to alert the operator if a differential temperature greater than a second predetermined amount exists between the bottom temperature and the next temperature above bottom on the rectifier column.

20. The method for preventing ethanol buildup in a column of claim 19, wherein said Advisory may states: “Warning—Low Temperature at bottom temperature sensor—Ethanol in Rectifier Bottoms—Immediate corrective action required!”.

21. The method for preventing ethanol buildup in a column of claim 15, further comprising a DCS and an operator, wherein said first action comprises programming the DCS with the proper pressure/temperature correlation for the beer column so the operator will know at all times if the column bottom temperature is correct.

22. The method for preventing ethanol buildup in a column of claim 21, further comprising indicating correct temperature as normal and indicating a change color when a deviation of 0.3 degrees occurs.

23. The method for preventing ethanol buildup in a column of claim 15, further comprising a DCS and an operator, wherein said third action comprises programming the DCS with a pop-up screen to alert the operator if the bottom temperature is 4.4 degrees below normal.

24. The method for preventing ethanol buildup in a column of claim 23, wherein said Advisory may states: “Alarm—Low Low Temperature at bottom temperature sensor—Ethanol concentration˜1% in Rectifier Bottoms—Divert to Beer Well!”.
